(19) United States
(12) Patent Application Publication
(10) Pub. No.: US 2021/0264153 A1
(43) Pub. Date: Aug. 26, 2021

(54) MACHINE LEARNING METHOD AND APPARATUS FOR DETECTION AND CONTINUOUS FEATURE COMPARISON

(71) Applicant: CACI, Inc.- Federal, Arlington, VA (US)

(72) Inventors: Charles VISS, Denver, CO (US); Zachary JORGENSEN, Aurora, CO (US); Ross MASSEY, Arlington, VA (US); Wolfgang KERN, Arlington, VA (US); Tyler STAUDINGER, Denver, CO (US)

(73) Assignee: CACI, Inc.- Federal, Arlington, VA (US)

(21) Appl. No.: 17/120,356

(22) Filed: Dec. 14, 2020

Related U.S. Application Data
(60) Provisional application No. 62/979,801, filed on Feb. 21, 2020.

(51) Int. Cl. G06K 9/00; G06K 9/70; G06F 9/54; G06K 9/62

(52) U.S. Cl. CPC G06K 9/00671; G06K 9/6284; G06F 9/54; G06K 9/70

(57) ABSTRACT

Methods, systems, and apparatuses, among other things, may perform persistent object tracking and reidentification through detection and continuous feature comparison. For example, video frames may be received (e.g., from a camera, an application, or a data storage device) and an object of interest may be detected at a first position in a video frame and the object of interest may be detected at a second position in another video frame. A track associated with the object of interest may be generated based on the detected first and second positions of the object of interest.

### CROSS-REFERENCE TO RELATED APPLICATIONS

This application claims the benefit of U.S. Provisional Application No. 62/979,801 filed on Feb. 21, 2020 and entitled “Machine Learning Method and Apparatus for Detection and Continuous Feature Comparison,” which is hereby incorporated by reference herein in its entirety. This disclosure relates to (i) U.S. provisional application 62/979,810 filed on Feb. 21, 2020 and entitled “Method and Apparatus for Object Detection and Prediction Employing Neural Networks,” (ii) U.S. nonprovisional application concurrently filed herewith under Docket No. 046850.025201 and entitled “Systems and Methods for Few Shot Object Detection,” (iii) U.S. provisional application 62/979,824 filed on Feb. 21, 2020 and entitled “Machine Learning Method and Apparatus for Labeling Image Data,” (iv) U.S. nonprovisional application concurrently filed herewith under Docket No. 046850.025211 and entitled “Systems and Methods for Labeling Data,” and (v) U.S. nonprovisional application concurrently filed herewith under Docket No. 046850.025281 and entitled “Reasoning From Surveillance Video via Computer Vision-Based Multi-Object Tracking and Spatiotemporal Proximity Graphs,” the content of each of which is being incorporated by reference herein in its entirety.

### FIELD

This application is generally related to machine learning methods and apparatuses for detection and continuous feature comparison for tracking and reidentification of an object.

### BACKGROUND

There are a number of different video storage solutions, each presenting a balance of transfer speed, balance, and capacity. Because each frame of video may contain a great deal of information (e.g., audio, visuals, timestamps, metadata, etc.), users must typically choose between speed and capacity, particularly when archiving video data. Accordingly, a need exists to improve the storage and retrieval of full motion video data in memory.

Analysis of manual full-motion is expensive and time consuming. Hours of video streams must be consumed by analysts. Unfortunately, only a relatively small portion of a video may contain actual relevant information. For example, raw video captured from surveillance platforms every year exceed an amount that can be realistically exploited by human analysts. Moreover, human analysts can easily miss important details due to fatigue and information overload. Other full-motion video detection systems also do not discriminate among instances of the same class. This directly affects reliability. Consequently, important events may go unnoticed and strategic opportunities may be missed. A need thus exists to accurately and efficiently analyze video information in a way that can be efficiently stored and accessed (e.g., by downstream applications).

### SUMMARY

The foregoing needs are met, to a great extent, by the disclosed apparatus, system and method for efficiently labelling image data.

One aspect of the application is directed to a method of performing persistent object tracking and reidentification through detection and continuous feature comparison. For example, video or video frames may be received, e.g., from a camera, an application, or a data storage device.

In some embodiments, an object of interest may be detected at a first position in a video (e.g., a first video frame or a first segment of the video) and the object of interest may be detected at a second position in the video (e.g., a second video frame or a second segment of the video). For example, a feature of the object of interest may be detected in a first video frame or a first segment of the video and the detected feature may be used to identify the object of interest in a second video frame or a second segment of the video. Moreover, a track associated with the object of interest may be generated based on the detected first and second positions of the object of interest. In some embodiments, a second track associated with the object of interest may be compared to a first track associated with the object of interest (e.g., a stored track). Moreover, based on the comparison, the first track may be extended to include the second track. In some embodiments, a propagation of the first track may be predicted and the comparison of the first track and the second track may be based on the predicted propagation.

In some embodiments, a change of viewpoint may be identified within the video (e.g., from the first video frame to the second video frame) and the object of interest may be detected based on the change of viewpoint. In some embodiments, the object of interest may be compared to one or more stored objects and identified based on the comparison. For example, a track associated with the object of interest may include a label or object identifier associated with the object of interest. Moreover, a track associated with the object identifier may include a class identifier associated with the object of interest.

In an embodiment, a machine learning technique processes videos in real-time and outputs tracking information of detected objects. More specifically, each individual instance is tracked. The machine learning model will reidentify a track that is temporarily occluded or deemed out of view.

In some embodiments, tracking information may be transmitted to a downstream application. In an embodiment, alerts can be configured to notify an analyst whenever a specific object or person appears in a video.

The above summary may present a simplified overview of some embodiments of the invention in order to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention. These drawings should not be construed as limiting the invention and are intended only to be illustrative.

FIG. 1 is a schematic representation of an architecture of a machine learning model for tracking and reidentification of an object according to an aspect of the application.

FIG. 2 is a diagram illustrating a graphic user interface for tracking and reidentification of an object on a computer display according to an aspect of the application.

FIG. 3 is a diagram illustrating a graphic user interface for tracking and reidentification of an object on a computer display according to an aspect of the application.

FIG. 4 illustrates an exemplary flowchart of a method to track an object of interest in accordance with the present disclosure.

FIG. 5 illustrates a system diagram of an exemplary communication network node.

FIG. 6 illustrates a block diagram of an exemplary computing system.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

It has been determined by the inventors and described herein that the application improves tracking and reidentification of objects via machine learning techniques (e.g., artificial neural networks). Artificial neural networks (ANNs) are models used in machine learning and may include statistical learning algorithms conceived from biological neural networks (particularly of the brain in the central nervous system of an animal) in machine learning and cognitive science. ANNs may refer generally to models that have artificial neurons (nodes) forming a network through synaptic interconnections (weights) and acquire problem-solving capability as the strengths of the interconnections are adjusted, e.g., at least throughout training. The terms ‘artificial neural network’ and ‘neural network’ may be used interchangeably herein.

An ANN may be configured to detect an activity associated with an entity based on input image(s) or other sensed information. An ANN is a network or circuit of artificial neurons or nodes. Such artificial networks may be used for predictive modeling.

The prediction models may be and/or include one or more neural networks (e.g., deep neural networks, artificial neural networks, or other neural networks), other machine learning models, or other prediction models. As an example, the neural networks referred to variously herein may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections may be enforcing or inhibitory, in their effect on the activation state of connected neural units. These neural network systems may be self-learning and trained, rather than explicitly programmed, and may perform significantly better in certain areas of problem solving, as compared to traditional computer programs. In some embodiments, neural networks may include multiple layers (e.g., where a signal path traverses from input layers to output layers). In some embodiments, back propagation techniques may be utilized to train the neural networks, where forward stimulation is used to reset weights on the front neural units. In some embodiments, stimulation and inhibition for neural networks may be more free-flowing, with connections interacting in a more chaotic and complex fashion.

Disclosed implementations of artificial neural networks may apply a weight and transform the input data by applying a function, this transformation being a neural layer. The function may be linear or, more preferably, a nonlinear activation function, such as a logistic sigmoid, hyperbolic tangent (Tanh), or rectified linear activation function (ReLU) function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

Each of the herein-disclosed ANNs may be characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters can be set through learning to specify the architecture of the ANN.

Learning rate and accuracy of each ANN may rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters. The hyperparameters may include initial values of weights and biases between nodes, mini-batch size, iteration number, learning rate, and so forth. Furthermore, the model parameters may include a weight between nodes, a bias between nodes, and so forth. In general, the ANN is first trained by experimentally setting hyperparameters to various values, and based on the results of training, the hyperparameters can be set to optimal values that provide a stable learning rate and accuracy.

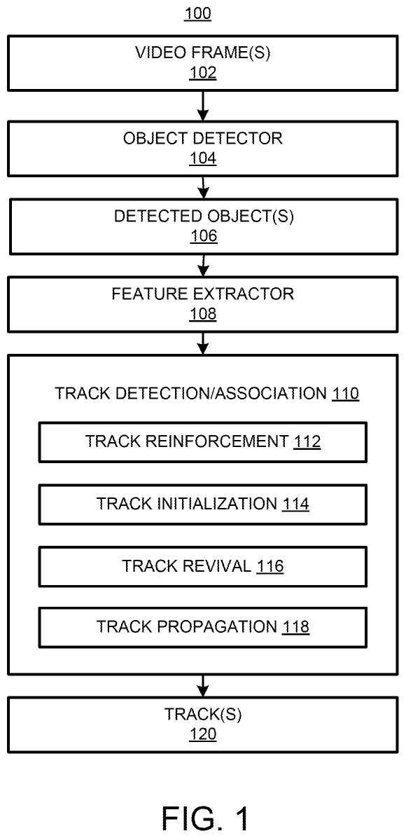

According to some embodiments, FIG. 1 illustrates a schematic representation of an architecture of a machine learning model 100 for tracking and reidentification of an object according to an aspect of the application. Some embodiments employ neural networks for both detection and reidentification. For example, the machine learning model may detect, track and reidentify instances of objects in full-motion video. Full motion video data may be taken from streams or archival footage. Moreover, the modular architecture may allow easy integration of different detection and feature extraction methods into a system.

In an embodiment, the machine learning model 100 may receive video 102, e.g., archival footage or live video streams, and the video 102 may include multiple frames or segments. In some embodiments, the video 102 may be received via a wired or wireless network connection from a database (e.g., a server storing image data) or an imaging system. For example, an imaging system may include an aerial vehicle (e.g., a manned or unmanned aerial vehicle), a fixed camera (e.g., a security camera, inspection camera, traffic light camera, etc.), a portable device (e.g., mobile phone, head-mounted device, video camera, etc.), or any other form of electronic image capture device. Moreover, the machine learning model 100 may receive the video 102 via a wired or wireless network connection.

In some embodiments, an object detector 104 may detect one or more detected objects 106 in the video 102. For example, video 102 may be passed through the object detector 104 at a user-specified rate, e.g., which can be fine-tuned to achieve a desired balance of speed and accuracy. In some embodiments, the object detector 104 may form a bounding box around each detected object 106 in each frame of video 102. Moreover, the object detector 104 may assign each detected object 106 a class label. In some embodiments, detections that do not exceed a confidence threshold may be discarded.

In some embodiments, detections from each frame of video 102 may be processed by a feature extractor 108. For example, the feature extractor 108 may use an image classification model to generate a set of image features (through traditional or deep learning methods) for each detected object 106. Moreover, the feature extractor 108 may employ computer vision approaches (e.g., a filter-based approach, histogram methods, etc.) or deep learning methods.

In some embodiments, track detection/association 110 may be performed based on the detected objects 106 and their associated features. For example, one or more object tracks may be detected based on criteria such as comparing object bounding boxes (e.g., distance or similarity) or appearance similarity.

In some embodiments, track reinforcement 112 may match detected objects 106 to existing active and pending tracks, e.g., first by matching to existing active tracks and then by matching to pending tracks. For example, active tracks may include tracks that were successfully matched to a detection in the previous frame and pending tracks may include tracks that were previously active but were not matched to any detections in previous frames (e.g., previous k frames, where 0<k<=sigma_p).

In some embodiments, processing active tracks may include iterating through detected objects 106 and, for each detection, computing a score for each track. For example, the score for each track may indicate how well a predicted bounding box of the track overlaps with that of the detection or how similar appearance features for the detection are to appearance features associated with the track. In some embodiments, a detected object 106 may be matched to a track if the score exceeds a threshold (e.g., a sigma_IOU threshold). In some embodiments, any active tracks that are not matched to a detection may become pending tracks. Moreover, active tracks that were matched to a detected object 106 have their Kalman filters updated based on any new detections. In some embodiments, any track that has been pending for too long (e.g., more than sigma_p frames) may have its status changed from “pending” to “finished.” Also, in some embodiments, a finished track may be discarded if the finished track does not include at least one high-confidence detection (e.g., confidence above sigma_h).

In some embodiments, track initialization 114 may include comparing detected objects 106 in each frame of the video 102. For example, a change in position or location of detected objects 106 from one frame to the next may be used to initiate a new track. In some embodiments, any pending track that is matched to a new detection may become active again and its Kalman filter may be updated based on the new detection.

In some embodiments, track revival 116 may be based on a re-identification step. For example, an attempt may be made to revive any finished tracks that have not been finished for a threshold number of frames, e.g., based on high visual similarity to one of the unmatched detections. For example, a track matching a finished track may be assigned a track identifier that is the same as a track identifier assigned to the finished track. In some embodiments, track revival 116 may occur as active tracks, over time, appear to include the same object as a finished track. Therefore, in some embodiments, a basis for matching an active track to a finished track may include more than just the initial appearance of an object. For example, at an initial appearance, the object may be occluded or in a very different orientation compared to a later frame. In some embodiments, parameters may be used to determine the number of frames in which an active track is eligible to be associated to a finished track or the number of image chips to use for visual comparison.

In some embodiments, track propagation 118 may be used to predict part of a track, e.g., if detections are not available for a given frame. For example, active or pending tracks may be propagated via a track predictor (e.g., a Kalman filter track predictor or neural network object tracker),In some embodiments, for each finished track, interpolation may be applied to a sequence of bounding boxes to fill in any gaps (e.g., due to missing detections, poor track prediction, etc.).

In some embodiments, track detection/association 110 may output a set of tracks 120 for visualization or for use by downstream applications.

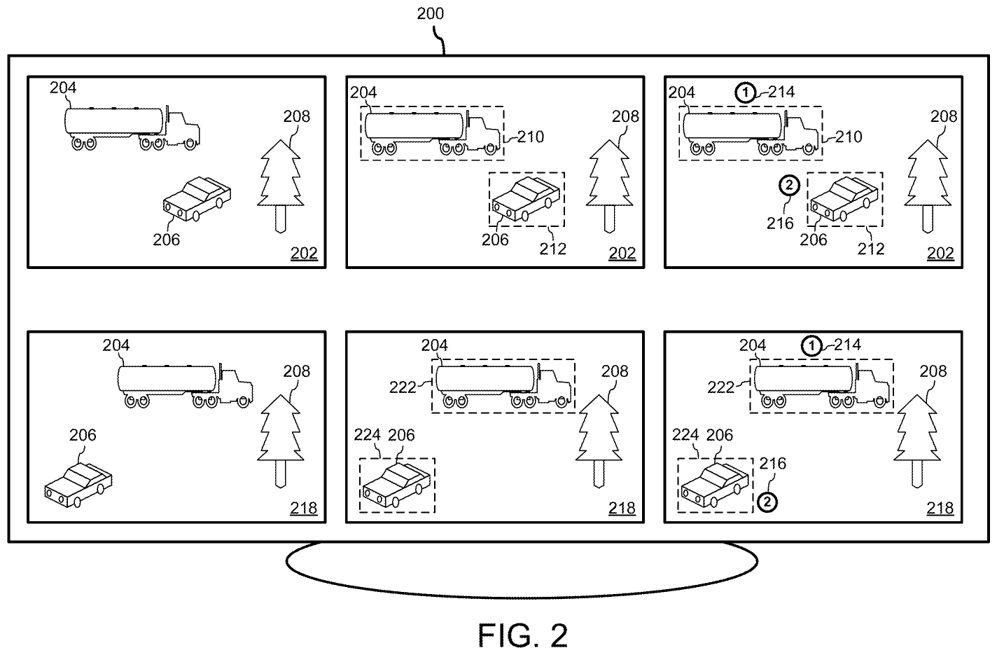

FIG. 2 is a diagram illustrating a graphic user interface (GUI) for tracking and reidentification of objects of interest on a computer display 200 according to an aspect of the application. For example, video 102 may include individual video 202. Video 202 may include multiple objects, e.g., truck 204, car 206, and tree 208. Video 102 may be received by object detector 104 and, as illustrated, object detector 104 may detect one or more objects of interest, e.g., truck 204 and car 206. As illustrated, bounding boxes (e.g., bounding boxes 210/212) may be used by the object detector 104 to identify the objects of interest. In some embodiments, bounding boxes 201/212 may be associated with attributes such as position within the frame, position relative to other objects, etc. Moreover, feature extractor 108 may identify features associated with the objects of interest, e.g., truck 204 and car 206. Track detection/association 110 may associate a track with each object of interest, e.g., track 214 with truck 204 and track 216 with car 206.

As further illustrated in FIG. 2, video 102 may include individual video frame 218, including multiple objects, e.g., truck 204, car 206, and tree 208. Video 102 may be received by object detector 104. Based on the previous detections from video frame 202 and one or more features associated with previously identified objects of interest, object detector 104 may objects of interest matching truck 204 and car 206. As illustrated, bounding boxes (e.g., bounding boxes 210/212) may be used by the object detector 104 to identify the objects of interest and the feature extractor 108 may identify features associated with the objects of interest, e.g., truck 204 and car 206.

According to some embodiments, information associated with the detected objects of interest in video frame 202 may be compared with information associated with the detected objects of interest in video frame 218. For example, position information associated with bounding boxes 222/224 may be compared with position information associated with bounding boxes 201/212. Accordingly, it may be determined that objects of interest (e.g., track 204 and car 206) have changed location in video frame 218 relative to video frame 202. Track detection/association 110 may incorporate the movement (e.g., change in position) of the objects of interest (e.g., truck 204 and car 206) into the track associated with each object of interest, e.g., track 214 with truck 204 and track 216 with car 206.

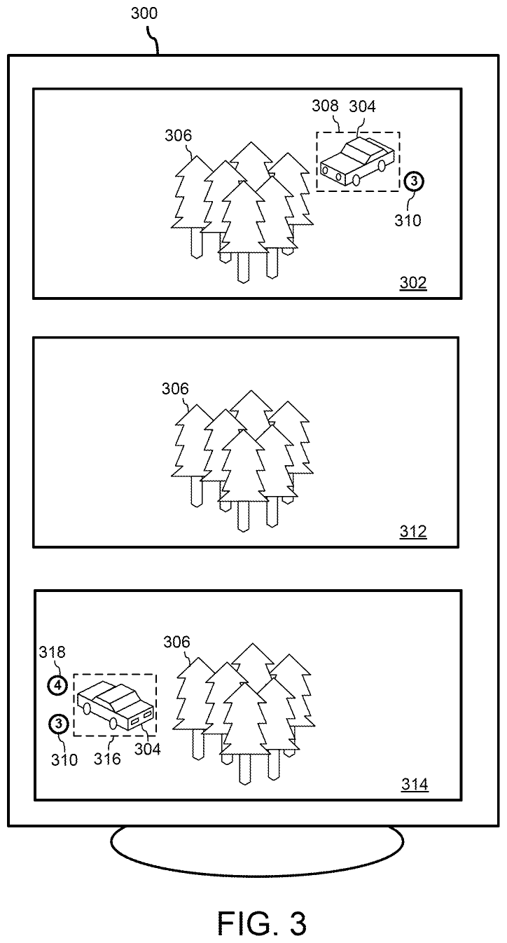

FIG. 3 is a diagram illustrating a GUI for tracking and reidentification of objects of interest on a computer display 300 according to an aspect of the application. For example, video 102 may include individual video frame 302. Video frame 302 may include multiple objects, e.g., car 304 and group of trees 306. Video frame 302 may be received by object detector 104 and, as illustrated, object detector 104 may detect one or more objects of interest, e.g., car 206. As illustrated, bounding boxes (e.g., bounding box 308) may be used by the object detector 104 to identify the objects of interest. In some embodiments, bounding box 308 may be associated with attributes such as position within the frame, position relative to other objects, etc. Moreover, feature extractor 108 may identify features associated with the objects of interest, e.g., car 304. Track detection/association 110 may associate a track with each object of interest, e.g., track initialization 114 initiating track 310 for car 304.

As further illustrated in FIG. 3, video 102 may include individual video frame 312, including multiple objects, e.g., group of tree 306. Video 102 may be received by object detector 104. As illustrated, object detector 104 may detect no objects of interest in video frame 312. According to some embodiments, track 310 may change from an active status to a pending status, e.g., since car 304, the object of interest associated with track 310, is no longer present in the video frame 312. Moreover, track 310 may be changed to finished, e.g., depending on settings specifying a number of frames in which an object of interest associated with a track is not present.

As illustrated in FIG. 3, video 102 may include individual video frame 314. Video frame 314 may include multiple objects, e.g., car 304 and group of trees 306. In the illustrated example, car 304 may be identified based on the previous detection of car 304 in video frame 302. For example, one or more features extracted from video frame 302 may be used by the object detector 104 to detect and identify car 304 in video frame 302. As illustrated, bounding boxes (e.g., bounding box 316) may be used by the object detector 104 to identify the objects of interest. In some embodiments, bounding box 316 may be associated with attributes such as position within the frame, position relative to other objects, etc. Moreover, feature extractor 108 may identify features associated with the objects of interest, car 304. Track detection/association 110 may associate a track with each object of interest, e.g., track 318 with car 304.

According to some embodiments, track revival 116 or track propagation 118 may be used to associate track 318 with track 310. For example, track 310 may be revived from by changing the identifier for track 318 to match the identifier for track 310. In some embodiments, track propagation 118 may predict an extension for track 310 and track 318 may be associated with track 310 by comparing track 318 with the extension of track 310.

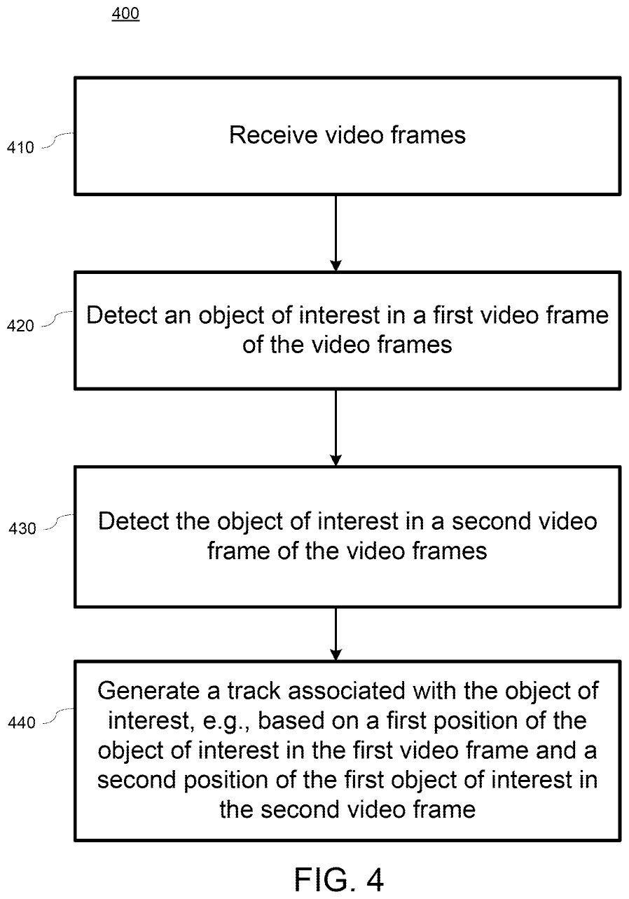

FIG. 4 illustrates an exemplary flowchart of a method 400 to track an object of interest. The method 400 may be performed at a network device, UE, desktop, laptop, mobile device, server device, or by multiple devices in communication with one another. In some examples, the method 400 is performed by processing logic, including hardware, firmware, software, or a combination thereof. In some examples, the method 400 is performed by a processor executing code stored in a computer-readable medium (e.g., memory).

As shown in method 400, at block 410, there may be receipt of video frames. In some embodiments, video frames may be received in the form of live streaming video, stored video received from a database, or a query including the video frames. For example, the video frames may be received from a device directed to a server. In some embodiments, the entire system may be capable of processing videos in real-time and may, for example, automate full-motion video analysis and alerting.

As shown in method 400, at block 420, one or more objects of interest may be detected in a first video frame of the video frames. In an embodiment, an interactive mode may allow an analyst to select specific objects to be tracked or ignored over the duration of a video. Moreover, an interactive mode may allow an analyst to condition the tracker to be based upon specific objects of interest and given images of that object (e.g., an image of a specific vehicle or person). The analyst may also tune the system in real-time to be more or less sensitive in order to achieve a desired balance between true detections and false alarms.

As shown in method 400, at block 430, the object of interest may be detected (e.g., re-identified) in a second video frame of the video frames. According to some embodiments, method 400 may detect one or more features associated with the object of interest to identify the object of interest in the second frame. According to another embodiment, a machine learning model may offer reidentification of tracked objects that have been temporarily occluded or deemed out of view. For instance, tracked objects may be continuously extracted via artificial neural networks trained to perform instance reidentification.

As shown in method 400, at block 440, a track associated with the object of interest may be generated, e.g., based on a first position of the object of interest in the first video frame and a second position of the first object of interest in the second video frame. According to some embodiments, a new track associated with the object of interest may be identified. Moreover, according to some embodiments, an active track (e.g., a pre-existing track in an active state) or finished track (e.g., a pre-existing track in a non-active state) may be associated with the object of interest. For example, currently active tracks may be compared to previously finished tracks, and a finished track may be revived when feature similarity is sufficiently high. Moreover, feature information may also be used to filter detections and tracks whenever an analyst provides input regarding which specific objects should be tracked.

According to some embodiments, a detected object may be matched with active or pending tracks based on an intersection-over-union (IoU), shape comparison, and feature similarity. Tracks with missing or occluded detections may be propagated via Kalman filter state prediction. Further, unmatched detections may initialize new tracks eligible to be reidentified with previously finished tracks for a specified time interval. According to some embodiments, all tracking parameters may be exposed to the user., e.g., allowing an analyst to tune a model to specific video domains for optimal performance

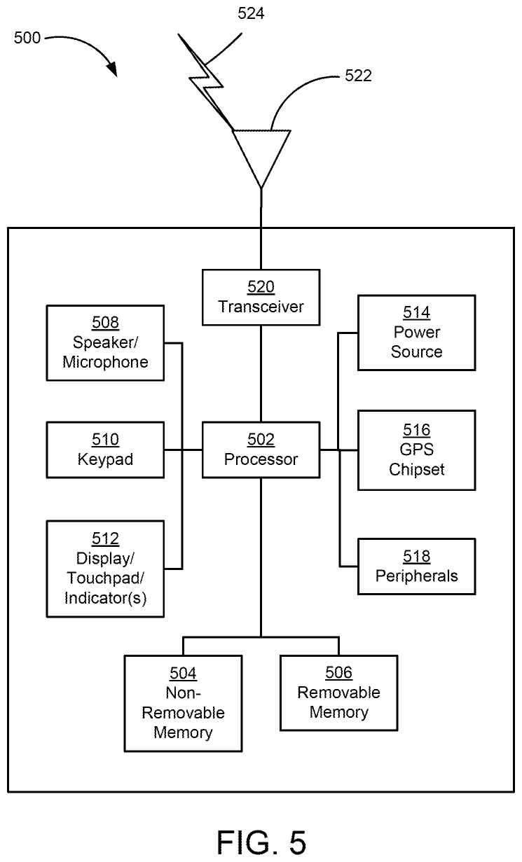

FIG. 5 is a block diagram of an exemplary hardware/software architecture of a node 500 of a network, such as clients, servers, or proxies, which may operate as an server, gateway, device, or other node in a network. The node 500 may include a processor 502, non-removable memory 504, removable memory 506, a speaker/microphone 508, a keypad 510, a display, touchpad, and/or indicators 512, a power source 514, a global positioning system (GPS) chipset 516, and other peripherals 518. The node 500 may also include communication circuitry, such as a transceiver 520 and a transmit/receive element 522 in communication with a communications network 524. The node 500 may include any sub-combination of the foregoing elements while remaining consistent with an embodiment.

The processor 502 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 502 may execute computer-executable instructions stored in the memory (e.g., memory 504 and/or memory 506) of the node 500 in order to perform the various required functions of the node 500. For example, the processor 502 may perform signal coding, data processing, power control, input/output processing, and/or any other functionality that enables the node 500 to operate in a wireless or wired environment. The processor 502 may run application-layer programs (e.g., browsers) and/or radio-access-layer (RAN) programs and/or other communications programs. The processor 502 may also perform security operations, such as authentication, security key agreement, and/or cryptographic operations. The security operations may be performed, for example, at the access layer and/or application layer.

As shown in FIG. 5, the processor 502 is coupled to its communication circuitry (e.g., transceiver 520 and transmit/receive element 522). The processor 502, through the execution of computer-executable instructions, may control the communication circuitry to cause the node 500 to communicate with other nodes via the network to which it is connected. While FIG. 5 depicts the processor 502 and the transceiver 520 as separate components, the processor 502 and the transceiver 520 may be integrated together in an electronic package or chip.

The transmit/receive element 522 may be configured to transmit signals to, or receive signals from, other nodes, including servers, gateways, wireless devices, and the like. For example, in an embodiment, the transmit/receive element 522 may be an antenna configured to transmit and/or receive RF signals. The transmit/receive element 522 may support various networks and air interfaces, such as WLAN, WPAN, cellular, and the like. In an embodiment, the transmit/receive element 522 may be an emitter/detector configured to transmit and/or receive IR, UV, or visible light signals, for example. In yet another embodiment, the transmit/receive element 522 may be configured to transmit and receive both RF and light signals. The transmit/receive element 522 may be configured to transmit and/or receive any combination of wireless or wired signals.

In addition, although the transmit/receive element 522 is depicted in FIG. 5 as a single element, the node 500 may include any number of transmit/receive elements 522. More specifically, the node 500 may employ multiple-input and multiple-output (MIMO) technology. Thus, in an embodiment, the node 500 may include two or more transmit/receive elements 522 (e.g., multiple antennas) for transmitting and receiving wireless signals.

The transceiver 520 may be configured to modulate the signals to be transmitted by the transmit/receive element 522 and to demodulate the signals that are received by the transmit/receive element 522. As noted above, the node 500 may have multi-mode capabilities. Thus, the transceiver 520 may include multiple transceivers for enabling the node 500 to communicate via multiple RATs, such as Universal Terrestrial Radio Access (UTRA) and IEEE 802.11, for example.

The processor 502 may access information from, and store data in, any type of suitable memory, such as the non-removable memory 504 and/or the removable memory 506. For example, the processor 502 may store session context in its memory, as described above. The non-removable memory 504 may include random-access memory (RAM), read-only memory (ROM), a hard disk, or any other type of memory storage device. The removable memory 506 may include a subscriber identity module (SIM) card, a memory stick, a secure digital (SD) memory card, and the like. In other embodiments, the processor 502 may access information from, and store data in, memory that is not physically located on the node 500, such as on a server or a home computer.

The processor 502 may receive power from the power source 514 and may be configured to distribute and/or control the power to the other components in the node 500. The power source 514 may be any suitable device for powering the node 500. For example, the power source 514 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 502 may also be coupled to the GPS chipset 516, which is configured to provide location information (e.g., longitude and latitude) regarding the current location of the node 500. The node 500 may acquire location information by way of any suitable location-determination method while remaining consistent with an embodiment.

The processor 502 may further be coupled to other peripherals 518, which may include one or more software and/or hardware modules that provide additional features, functionality, and/or wired or wireless connectivity. For example, the peripherals 518 may include various sensors such as an accelerometer, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, an Internet browser, and the like.

The node 500 may be embodied in other apparatuses or devices. The node 500 may connect to other components, modules, or systems of such apparatuses or devices via one or more interconnect interfaces, such as an interconnect interface that may comprise one of the peripherals 518.

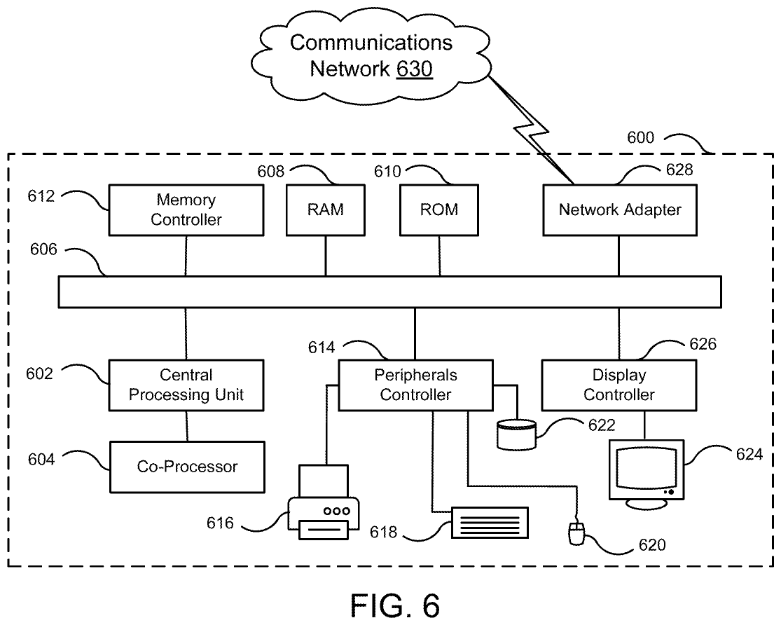

FIG. 6 is a block diagram of an exemplary computing system 600 that may be used to implement one or more nodes (e.g., clients, servers, or proxies) of a network, and which may operate as a server, gateway, device, or other node in a network. For example, computing system 600 may include a network adapter 628 in communication with a communications network 630. The computing system 600 may comprise a computer or server and may be controlled primarily by computer-readable instructions, which may be in the form of software, by whatever means such software is stored or accessed. Such computer-readable instructions may be executed within a processor, such as a central processing unit (CPU) 602, to cause the computing system 600 to effectuate various operations. In many known workstations, servers, and personal computers, the CPU 602 is implemented by a single-chip CPU called a microprocessor. In other machines, the CPU 602 may comprise multiple processors. A co-processor 604 is an optional processor, distinct from the CPU 602 that performs additional functions or assists the CPU 602.

In operation, the CPU 602 fetches, decodes, executes instructions, and transfers information to and from other resources via the computer's main data-transfer path, a system bus 606. Such a system bus 606 connects the components in the computing system 600 and defines the medium for data exchange. The system bus 606 typically includes data lines for sending data, address lines for sending addresses, and control lines for sending interrupts and for operating the system bus 606. An example of such a system bus 606 is the PCI (Peripheral Component Interconnect) bus.

Memories coupled to the system bus 606 include RAM 608 and ROM 610. Such memories include circuitry that allows information to be stored and retrieved. The ROM 610 generally contains stored data that cannot easily be modified. Data stored in the RAM 608 may be read or changed by the CPU 602 or other hardware devices. Access to the RAM 608 and/or the ROM 610 may be controlled by a memory controller 612. The memory controller 612 may provide an address translation function that translates virtual addresses into physical addresses as instructions are executed. The memory controller 612 may also provide a memory protection function that isolates processes within the system and isolates system processes from user processes. Thus, a program running in a first mode may access only memory mapped by its own process virtual address space. It cannot access memory within another process's virtual address space unless memory sharing between the processes has been set up.

In addition, the computing system 600 may contain a peripherals controller 614 responsible for communicating instructions from the CPU 602 to peripherals, such as a printer 616, a keyboard 618, a mouse 620, and a disk drive 622.

A display 624, which is controlled by a display controller 626, is used to display visual output generated by the computing system 600. Such visual output may include text, graphics, animated graphics, and video. The display 624 may be implemented with a CRT-based video display, an LCD-based flat-panel display, gas plasma-based flat-panel display, or a touch-panel. The display controller 626 includes electronic components required to generate a video signal that is sent to the display 624.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving a plurality of video frames;
detecting a first object of interest in a first video frame of the plurality of video frames;
detecting the first object of interest in a second video frame of the plurality of video frames; and
generating, based on a first position of the first object in the first video frame and a second position of the first object in the second video frame, a first track associated with the first object of interest.

2. The method of claim 1, further comprising:
extracting a first feature associated with the first object of interest from the first video frame;
extracting a second feature associated with a second object of interest from the second video frame; and
comparing the first feature and the second feature, wherein
detecting the first object of interest in the second video frame is based on the comparison.

3. The method of claim 1, further comprising:
identifying a change of viewpoint from the first video frame to the second video frame, wherein detecting the first object of interest in the second video frame is based on the change of viewpoint.

4. The method of claim 1 further comprising:
comparing the first object of interest to a plurality of stored objects; and
identifying the first object of interest based on the comparison.

5. The method of claim 1, further comprising assigning an object identifier to the first object of interest, wherein the first track includes the assigned object identifier.

6. The method of claim 1, further comprising assigning a class identifier to the first object of interest, wherein the first track includes the assigned class identifier.

7. The method of claim 1, further comprising:
detecting the first object of interest in a third video frame of the plurality of video frames;
generating, based on the second position of the first object in the second video frame and a third position of the first object in the third video frame, a second track associated with the first object of interest;
comparing the first track and the second track; and
extending, based on the comparison, the first track to include the second track.

8. The method of claim 7, further comprising predicting a propagation of the first track, wherein the comparison of the first track and the second track is based on the predicted propagation.

9. The method of claim 1. further comprising:
comparing the first track with a plurality of stored tracks; and
extending, based on the comparison, a stored track of the plurality of stored tracks to include the first track.

10. The method of claim 1, further comprising transmitting the first track associated with the first object of interest to a downstream application.

11. A system comprising:
one or more processors; and
memory including instructions that, when executed by the one or more processors, cause the system to:
display a video;
detect a first object of interest in a first video segment of the video;
detect the first object of interest in a second video segment of the video; and
generate, based on a first position of the first object in the first video segment and a second position of the first object in the second video segment, a first track associated with the first object of interest.

12. The system of claim 11, wherein the instructions are further configured to cause the system to:
extract a first feature associated with the first object of interest from the first segment;
extract a second feature associated with a second object of interest from the second video segment; and
compare the first feature and the second feature, wherein
detecting the first object of interest in the second video segment is based on the comparison.

13. The system of claim 11, wherein the instructions are further configured to cause the system to identify a change of viewpoint from the first video segment to the second video segment, wherein detecting the first object of interest in the second video segment is based on the change of viewpoint.

14. The system of claim 11, wherein the instructions are further configured to cause the system to:
compare the first object of interest to a plurality of stored objects; and
identify the first object of interest based on the comparison.

15. The system of claim 11, wherein the instructions are further configured to cause the system to assign an object identifier to the first object of interest, wherein the first track includes the assigned object identifier.

16. The system of claim 11, wherein the instructions are further configured to assign a class identifier to the first object of interest, wherein the first track includes the assigned class identifier.

17. The system of claim 11, wherein the instructions are further configured to cause the system to:
detect the first object of interest in a third video segment of the video;
generate, based on the second position of the first object in the second video frame and a third position of the first object in the third video frame, a second track associated with the first object of interest;
compare the first track and the second track; and
extend, based on the comparison, the first track to include the second track.

18. The system of claim 17, wherein the instructions are further configured to predict a propagation of the first track, wherein the comparison of the first track and the second track is based on the predicted propagation.

19. The system of claim 11, wherein the instructions are further configured to cause the system to:
compare the first track with a plurality of stored tracks; and
extend, based on the comparison, a stored track of the plurality of stored tracks to include the first track.

20. A computer program product comprising:
a computer-readable storage medium; and
instructions stored on the computer-readable storage medium that, when executed by a processor, causes the processor to:
detect a first object of interest in a first video frame;
detect the first object of interest in a second video frame; and
generate, based on a first position of the first object in the first video frame and a second position of the first object in the second video frame, a first track associated with the first object of interest.
